(19) United States
(12) Patent Application Publication
(10) Pub. No.: US 2025/0113965 A1
(43) Pub. Date: Apr. 10, 2025

(54) ANIMAL EXCREMENT VACUUM DEVICE

(71) Applicant: Cornelius Robinson, JR., Seaside, CA (US)

(72) Inventor: Cornelius Robinson, JR., Seaside, CA (US)

(21) Appl. No.: 18/377,592

(22) Filed: Oct. 6, 2023

(51) Int. Cl. A47L 11/40; A01K 1/01

(52) U.S. Cl. CPC A47L 11/4044; A01K 1/01; A47L 11/4083; A47L 11/4088

(57) ABSTRACT

An animal excrement vacuum device for collecting the animal excrement from a ground surface via a suction force includes a housing with a vacuum pump arranged to cause the suction force to lift the animal excrement from the ground surface into a receptacle. A camera and a laser guide are used to present an image via a display to aim the vacuum pump at the animal excrement.

### (B) CROSS-REFERENCE TO RELATED APPLICATIONS

### Not Applicable

### (C) STATEMENT REGARDING FEDERALLY SPONSORED RESEARCH OR DEVELOPMENT

### Not Applicable

### (D) THE NAMES OF THE PARTIES TO A JOINT RESEARCH AGREEMENT

### Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### (F) STATEMENT REGARDING PRIOR DISCLOSURES BY THE INVENTOR OR JOINT INVENTOR

### Not Applicable

### (G) BACKGROUND OF THE INVENTION

### (1) Field of the Invention

The disclosure relates to animal excrement collection devices and more particularly pertains to a new animal excrement collection device for collecting the animal excrement from a ground surface via a suction force.

### (2) Description of Related Art Including Information Disclosed Under 37 CFR 1.97 and 1.98

The prior art describes various animal excrement collection devices which vacuum up the animal excrement. However, the prior art fails to describe such a device which uses a camera and a laser guide to aim the device at the animal excrement. Such a new device would be advantageous over the prior art by providing a convenient means of positioning the device appropriately such that the device is able to collect the animal excrement.

### (H) BRIEF SUMMARY OF THE INVENTION

An embodiment of the disclosure meets the needs presented above by generally comprising a housing which has a perimeter wall and is open on a bottom end of the perimeter wall. A tube is mounted in the housing and has an inlet end and an outlet end. The inlet end faces downwardly with respect to the housing. A vacuum pump is mounted to the tube and is configured to selectively urge air from the inlet end of the tube to the outlet end of the tube. A receptacle is coupled to the outlet end of the tube such that the receptacle is in fluid communication with the tube. A camera is mounted to the tube and faces downwardly with respect to the housing. A processor is operatively coupled to the camera and the vacuum pump. A display is mounted on an exterior of the housing and is operatively coupled to the processor. The processor is configured to present images captured by the camera on the display.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an animal excrement vacuum device according to an embodiment of the disclosure.

FIG. 2 is a rear view of an embodiment of the disclosure.

FIG. 3 is a first side view of an embodiment of the disclosure.

FIG. 4 is a second side view of an embodiment of the disclosure.

FIG. 5 is a top view of an embodiment of the disclosure.

FIG. 6 is a bottom view of an embodiment of the disclosure.

FIG. 7 is an in-use view of an embodiment of the disclosure.

FIG. 8 is front view of an embodiment of the disclosure with a pair of arms retracted from a full length and positioned in a use position.

FIG. 9 is a front view of an embodiment of the disclosure with a pair of arms retracted from a full length and positioned in a storage position.

### (J) DETAILED DESCRIPTION OF THE INVENTION

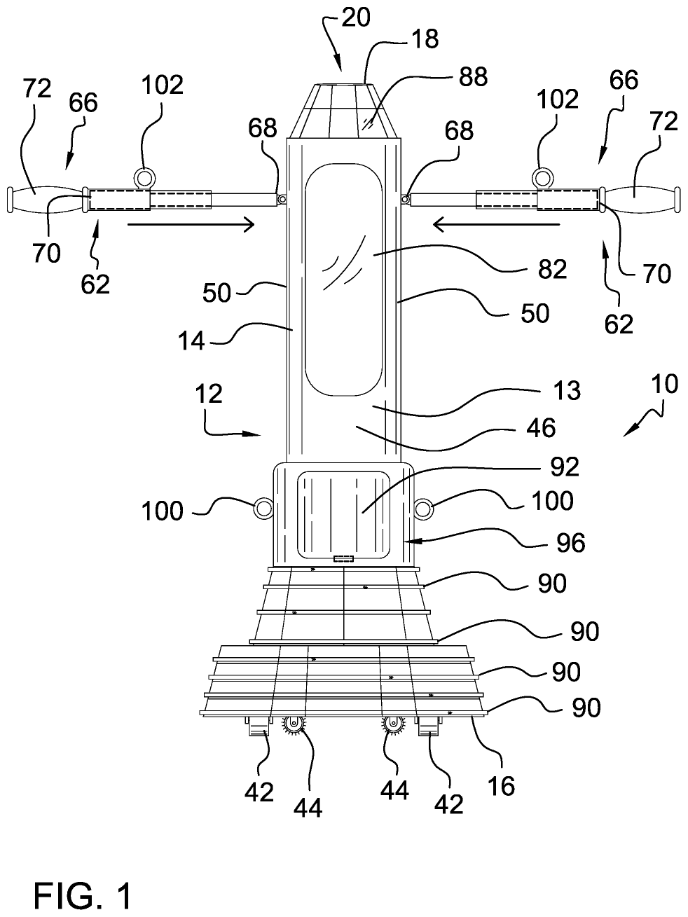

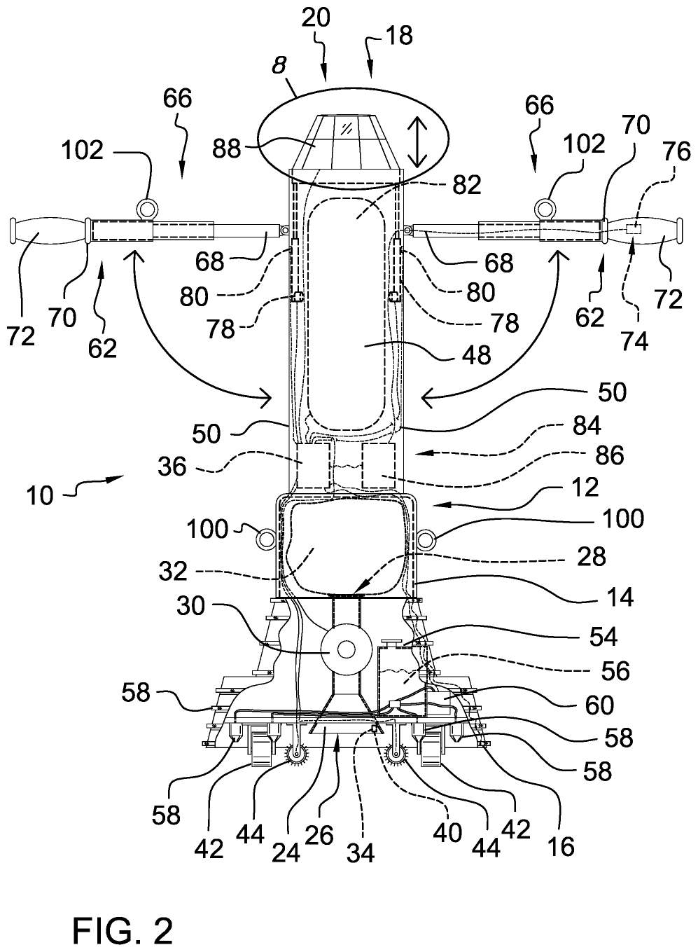

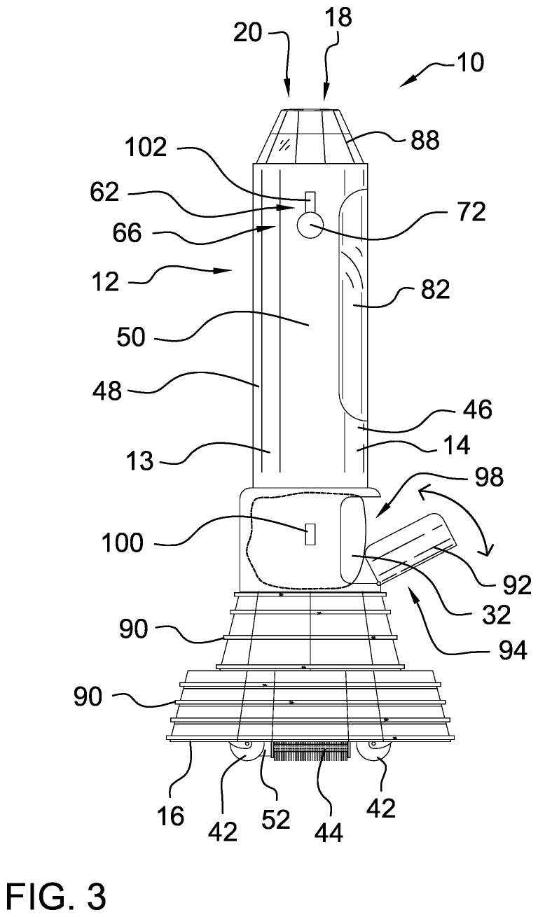

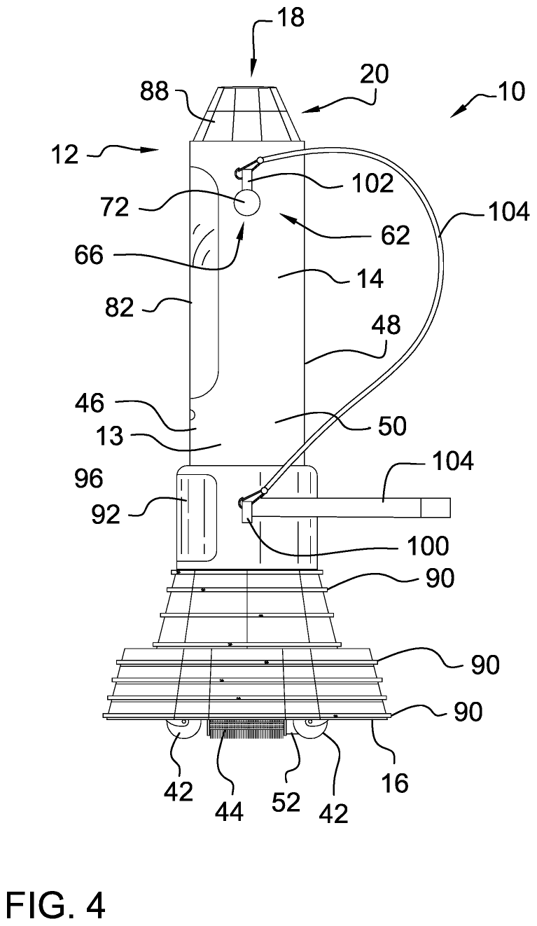

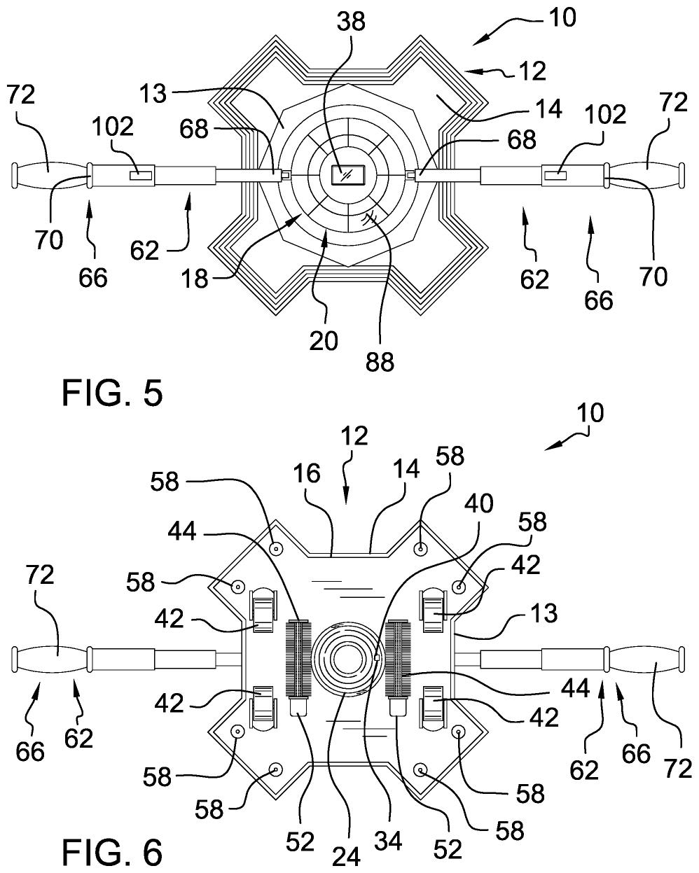

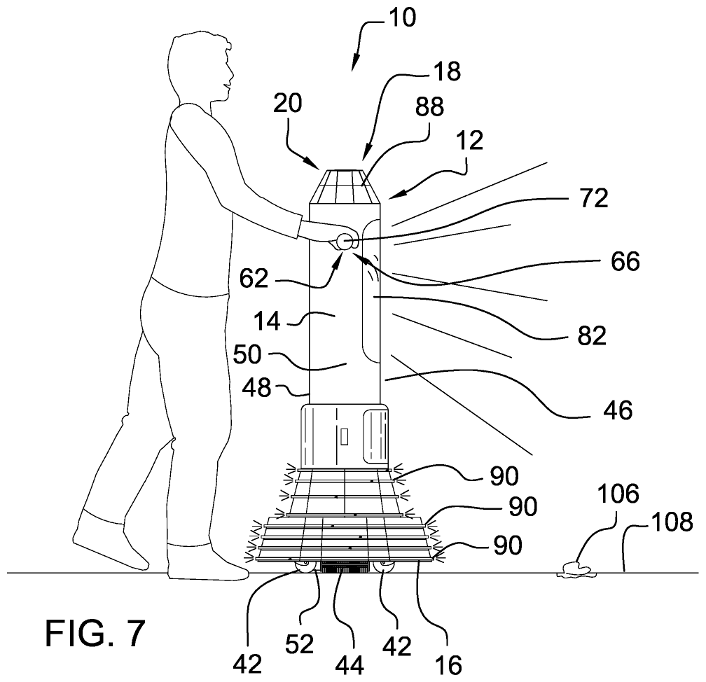

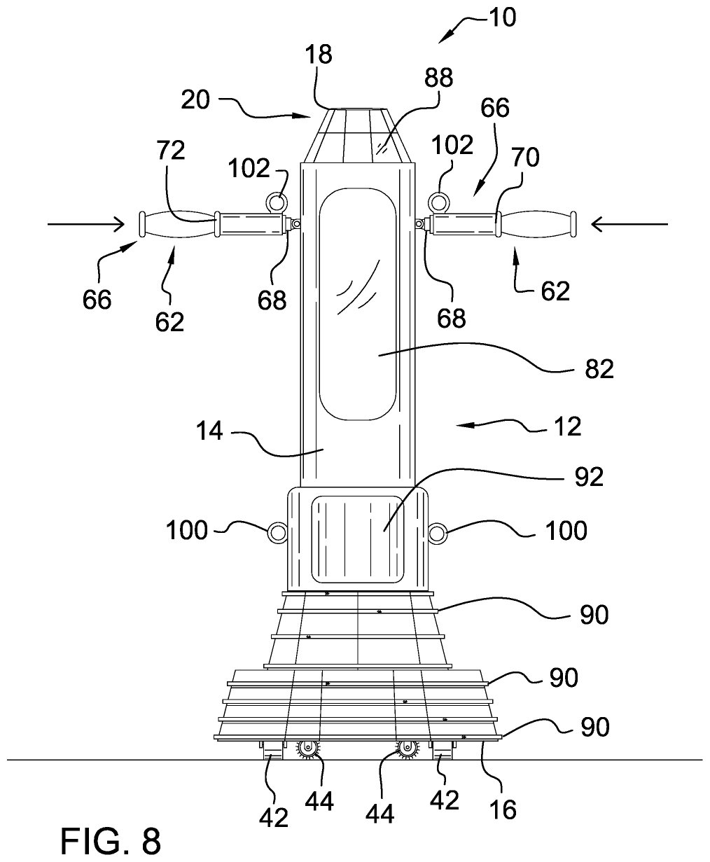

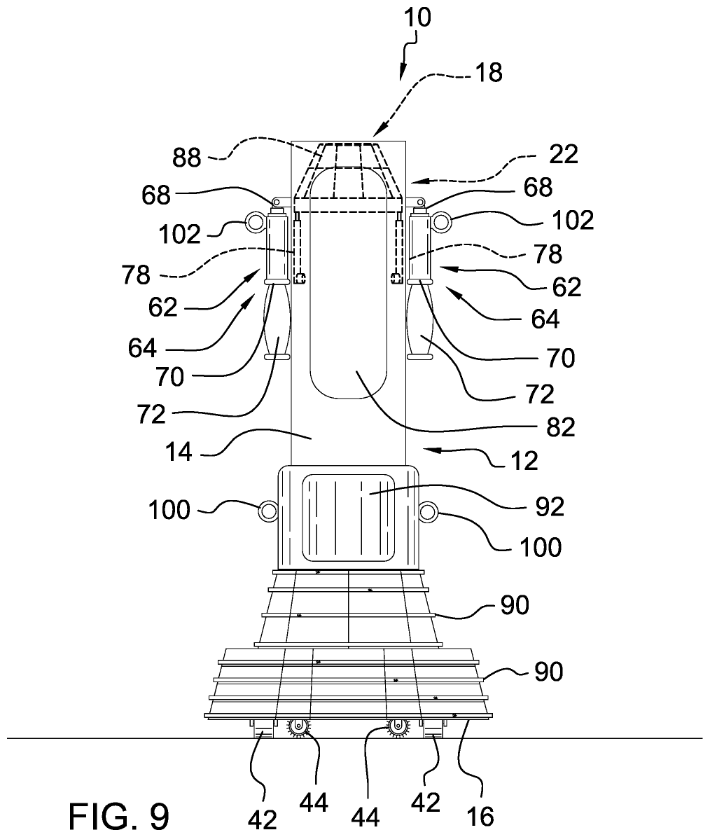

With reference now to the drawings, and in particular to FIGS. 1 through 9 thereof, a new animal excrement collection device embodying the principles and concepts of an embodiment of the disclosure and generally designated by the reference numeral 10 will be described.

As best illustrated in FIGS. 1 through 9, the animal excrement vacuum device 10 generally comprises a housing 12 which has a perimeter wall 14 and is open on a bottom end 16 of the perimeter wall 14. The housing 12 also has a top wall 18 which is coupled to the perimeter wall 14 and which is movable between a raised position 20 and a lowered position 22 with respect to the perimeter wall 14. The top wall 18 protrudes outwardly from the perimeter wall 14 when the top wall 18 is positioned in the raised position 20. A tube 24 is mounted in the housing 12 and has an inlet end 26 and an outlet end 28, and the inlet end 26 faces downwardly with respect to the housing 12. A vacuum pump 30 is mounted to the tube 24 and is configured to selectively urge air from the inlet end 26 of the tube 24 to the outlet end 28 of the tube 24, thereby generating a suction force at the inlet end 26 of the tube 24. The vacuum pump 30 includes a vacuum motor to drive the vacuum pump 30. A receptacle 32 is removably couplable to the outlet end 28 of the tube 24 such that the receptacle 32 is in fluid communication with the tube 24.

A camera 34 is mounted to the tube 24 and faces downwardly with respect to the housing 12. A processor 36 is operatively coupled to the camera 34 and the vacuum pump 30. A display 38 is mounted on an exterior 13 of the housing 12 and is operatively coupled to the processor 36. The processor 36 is configured to present images captured by the camera 34 on the display 38. The display 38 is positioned on the top wall 18 of the housing 12. A laser emitter 40 is mounted to the tube 24 and faces downwardly with respect to the housing 12. The laser emitter 40 is configured to emit a laser guide indicating a location which will experience the suction force when the vacuum pump 30 is activated.

A plurality of wheels 42 is rotatably coupled to the housing 12 and is positioned at the bottom end 16 of the perimeter wall 14. A pair of scrubbers 44 is rotatably coupled to the housing 12 and is positioned at the bottom end 16 of the perimeter wall 14. Each scrubber 44 of the pair of scrubbers 44 is spaced inwardly of the perimeter wall 14 of the housing 12, and the scrubbers 44 are oriented parallel to each other. Each scrubber 44 of the pair of scrubbers 44 is oriented to extend between a front side 46 and a rear side 48 of said housing 12. Each one of a pair of scrubber motors 52 is operatively coupled to an associated scrubber 44 of the pair of scrubbers 44 and to the processor 36.

A reservoir 54 is mounted in the housing 12, the reservoir 54 is configured to contain a cleaning fluid 56 such as water. A plurality of spray nozzles 58 is mounted in the housing 12 and is in fluid communication with the reservoir 54. Each spray nozzle 58 of the plurality of spray nozzles 58 has an outlet facing downwardly with respect to the housing 12. A cleaning pump 60 is in fluid communication with the reservoir 54 and the plurality of spray nozzles 58. The cleaning pump 60 is operatively coupled to the processor 36 and includes a cleaning motor to drive the cleaning pump 60. The cleaning pump 60 is configured to selectively urge the cleaning fluid 56 from the reservoir 54 through the plurality of spray nozzles 58.

A pair of arms 62 is mounted to the housing 12. Each arm 62 of the pair of arms 62 is positioned on an associated one of a pair of lateral sides 50 of the housing 12. Each arm 62 of the pair of arms 62 is pivotable between a storage position 64 and a use position 66. In the storage position 64, each arm 62 of the pair of arms 62 extends downwardly from a coupled end 68 of the arm 62 to a free end 70 of the arm 62 when. In the use position 66, each arm 62 of the pair of arms 62 extends laterally away from the housing 12 from the coupled end 68 to the free end 70. Each arm 62 of the pair of arms 62 is telescopically extendable to selectively adjust a length of the arm 62 from the coupled end 68 to the free end 70.

Each one of a pair of handles 72 is coupled to the free end 70 of an associated arm 62 of the pair of arms 62. An input 74 is operatively coupled to the processor 36 and is embedded in one of the pair of handles 72. The input 74 comprises a force sensor 76 such that when a user squeezes the one handle 72, the force sensor 76 detects the squeeze and sends an operational signal to the processor 36. The input 74 also may be mounted elsewhere, such as on the housing 12, and may include a button, a switch, a keypad, a touchscreen, or other suitable actuation means. A pair of lifts 78 is mounted in the housing 12 and is coupled to the top wall 18 and the perimeter wall 14. The pair of lifts 78 is operable to move the top wall 18 linearly between the raised position 20 and the lowered position 22.

A pair of arm position sensors 80 is mounted to the housing 12. Each arm position sensor 80 of the pair of arm position sensors 80 is configured to detect when an associated arm 62 of the pair of arms 62 is positioned in the storage position 64. Each arm position sensor 80 may comprise a proximity sensor, a button, a switch, or the like. Each arm position sensor 80 also may comprise electrical contacts which mate and transmit electricity therethrough when the arms 62 are positioned in the storage positions 64. The processor 36 is configured to cause the pair of lifts 78 to move the top wall 18 to the raised position 20 when each arm 62 of the pair of arms 62 is moved away from the storage position 64 and to cause the pair of lifts 78 to move the top wall 18 to the lowered position 22 when each arm 62 of the pair of arms 62 is moved into the storage position 64.

A guide light source 82 is coupled to a front side 46 of the housing 12 and is operatively coupled to the processor 36. The guide light source 82 is configured to emit a light forwardly with respect to the housing 12. A power supply 84 is electrically coupled to the processor 36 and comprises a battery 86. A solar cell 88 is mounted to the exterior 13 of the housing 12 and is positioned on the top wall 18. The solar cell 88 is electrically coupled to the battery 86. Additional lighting 90 may be mounted to the exterior 13 of the housing 12 near the bottom end 16 of the perimeter wall 14. The additional lighting 90 may increase visibility similar to the guide light source 82 and may be for ornamental effect. The additional lighting 90 may include neon light sources or other light sources which cause the additional lighting 90 to emit a pattern of flashing light using a plurality of visible colors.

A door 92 is coupled to the front side 46 of the housing 12, the door 92 is positioned adjacent to the receptacle 32 when the receptacle 32 is coupled to the outlet end 28 of the tube 24. The door 92 is movable between an open position 94 and a closed position 96. The receptacle 32 is accessible through an aperture 98 in the housing 12 only when the door 92 is in the open position 94. A pair of lower eyelets 100 is coupled to the housing 12, wherein each lower eyelet 100 of the pair of lower eyelets 100 is positioned on an associated one of the pair of lateral sides 50 of the housing 12. Each one of a pair of upper eyelets 102 is coupled to an associated arm 62 of the pair of arms 62. The pair of lower eyelets 100 and the pair of upper eyelets 102 are configured to attach to a plurality of straps 104 to facilitate carrying the housing 12. The upper and lower eyelets 100, 102 also may be alternatively positioned. The upper eyelets 102, for example, may also be mounted to the housing 12.

In use, the animal excrement vacuum device 10 is positioned on a ground surface 108 near a pile of animal excrement 106. The housing 12 is positioned over the animal excrement 106, using the display 38 to view the animal excrement 106 via the camera 34. The laser guide indicates a location on the ground surface 108 which will experience the suction force when the vacuum pump 30 is operated. Once the inlet end 26 of the tube 24 is aligned with the animal excrement 106, the vacuum pump 30 is operated to suck the animal excrement 106 into the receptacle 32. The receptacle 32 may be removed and replaced. The operation of the vacuum pump 30, the cleaning pump 60, and the scrubber motors 52 may be performed via the force sensor 76 of the input 74 or via another portion of the input 74 which may be mounted elsewhere one the housing 12 or be remote from the housing 12.

When operated, the cleaning pump 60 sprays the cleaning fluid 56 through the plurality of spray nozzles 58 against the ground surface 108 to clean the ground surface 108 of the animal excrement 106. The scrubbers 44 are also operated to clean the ground surface 108 through abrasive movements. The top wall 18 is movable between the raised and lowered positions 20, 22 by pivoting the arms 62, thereby causing the arm position sensors 80 to detect the changes of position of the arms 62. The solar cell 88 is exposed when the top wall 18 is positioned in the raised position 20, thereby facilitating charging the battery 86 via sunlight.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal excrement vacuum device comprising:
a housing having a perimeter wall and being open on a bottom end of the perimeter wall;
a tube being mounted in the housing and having an inlet end and an outlet end, the inlet end facing downwardly with respect to the housing;
a vacuum pump being mounted to the tube, the vacuum tube being configured to selectively urge air from the inlet end of the tube to the outlet end of the tube;
a receptacle being coupled to the outlet end of the tube such that the receptacle is in fluid communication with the tube;
a camera being mounted to the tube and facing downwardly with respect to the housing;
a processor being operatively coupled to the camera and the vacuum pump; and
a display being mounted on an exterior of the housing and being operatively coupled to the processor, the processor being configured to present images captured by the camera on the display.

2. The device of claim 1, further comprising a laser emitter being mounted to the tube and facing downwardly with respect to the housing, the laser emitter being configured to emit a laser guide indicating a location which will experience a suction force when the vacuum pump is activated.

3. The device of claim 1, wherein the housing has a top wall coupled to the perimeter wall, the top wall being movable between a raised position and a lowered position with respect to the perimeter wall, the top wall protruding outwardly from the perimeter wall when the top wall is positioned in the raised position.

4. The device of claim 3, wherein the display is positioned on the top wall of the housing.

5. The device of claim 3, further comprising a pair of arms being mounted to the housing, each arm of the pair of arms being positioned on an associated one of a pair of lateral sides of the housing.

6. The device of claim 5, wherein each arm of the pair of arms is pivotable between a storage position and a use position, each arm of the pair of arms extending downwardly from a coupled end of the arm to a free end of the arm when in the storage position, each arm of the pair of arms extending laterally away from the housing from the coupled end to the free end when in the use position, the animal excrement vacuum device further comprising:
a pair of lifts mounted in the housing, the pair of lifts being coupled to the top wall and the perimeter wall, the pair of lifts being operable to move the top wall linearly between the raised position and the lowered position; and
a pair of arm position sensors being mounted to the housing, each arm position sensor of the pair of arm position sensors being configured to detect when an associated arm of the pair of arms is positioned in the storage position, the processor being configured to cause the pair of lifts to move the top wall to the raised position when each arm of the pair of arms is moved away from the storage position, the processor being configured to cause the pair of lifts to move the top wall to the lowered position when each arm of the pair of arms is moved into the storage position.

7. The device of claim 5, further comprising:
a pair of handles, each handle of the pair of handles being coupled to the free end of an associated arm of the pair of arms; and
an input being operatively coupled to the processor, the input being embedded in one of the pair of handles.

8. The device of claim 7, wherein the input comprises a force sensor.

9. The device of claim 5, wherein each arm of the pair of arms is telescopically extendable to selectively adjust a length of the arm from the coupled end to the free end.

10. The device of claim 1, further comprising:
a pair of scrubbers being rotatably coupled to the housing, the pair of scrubbers being positioned at the bottom end of the perimeter wall; and
a pair of scrubber motors, each scrubber motor of the pair of scrubber motors being operatively coupled to an associated scrubber of the pair of scrubbers, the pair of scrubber motors being operatively coupled to the processor.

11. The device of claim 10, wherein the scrubbers of the pair of scrubbers are spaced inwardly of the perimeter wall of the housing.

12. The device of claim 10, wherein the scrubbers of the pair of scrubbers are oriented parallel to each other, each scrubber of the pair of scrubbers being oriented to extend between a front side and a rear side of said housing.

13. The device of claim 1, further comprising a plurality of wheels being rotatably coupled to the housing and being positioned at the bottom end of the perimeter wall.

14. The device of claim 1, further comprising:
a reservoir being mounted in the housing, the reservoir being configured to contain a cleaning fluid;
a plurality of spray nozzles being mounted in the housing and being in fluid communication with the reservoir, each spray nozzle of the plurality of spray nozzles having an outlet facing downwardly with respect to the housing; and
a cleaning pump being in fluid communication with the reservoir and the plurality of spray nozzles, the cleaning pump being operatively coupled to the processor, the cleaning pump being configured to selectively urge the cleaning fluid from the reservoir through the plurality of spray nozzles.

15. The device of claim 1, further comprising a guide light source being coupled to a front side of the housing and being operatively coupled to the processor, the guide light source being configured to emit a light forwardly with respect to the housing.

16. The device of claim 1, further comprising a power supply being electrically coupled to the processor.

17. The device of claim 16, wherein the power supply comprises a battery, the animal excrement vacuum device further comprising a solar cell mounted to the exterior of the housing, the solar cell being electrically coupled to the battery.

18. The device of claim 3, further comprising:
a pair of lower eyelets being coupled to the housing, each lower eyelet of the pair of lower eyelets being positioned on an associated one of a pair of lateral sides of the housing; and
a pair of upper eyelets, each upper eyelet being coupled to an associated arm of the pair of arms;
wherein the pair of lower eyelets and the pair of upper eyelets are configured to attach to a plurality of straps to facilitate carrying the housing.

19. An animal excrement vacuum device comprising:
a housing having a perimeter wall and being open on a bottom end of the perimeter wall, the housing having a top wall coupled to the perimeter wall, the top wall being movable between a raised position and a lowered position with respect to the perimeter wall, the top wall protruding outwardly from the perimeter wall when the top wall is positioned in the raised position;
a tube being mounted in the housing and having an inlet end and an outlet end, the inlet end facing downwardly with respect to the housing;
a vacuum pump being mounted to the tube, the vacuum tube being configured to selectively urge air from the inlet end of the tube to the outlet end of the tube;
a receptacle being removably couplable to the outlet end of the tube such that the receptacle is in fluid communication with the tube;
a camera being mounted to the tube and facing downwardly with respect to the housing;
a processor being operatively coupled to the camera and the vacuum pump;
a display being mounted on an exterior of the housing and being operatively coupled to the processor, the processor being configured to present images captured by the camera on the display, the display being positioned on the top wall of the housing;
a laser emitter being mounted to the tube and facing downwardly with respect to the housing, the laser emitter being configured to emit a laser guide indicating a location which will experience a suction force when the vacuum pump is activated;
a plurality of wheels being rotatably coupled to the housing and being positioned at the bottom end of the perimeter wall;
a pair of scrubbers being rotatably coupled to the housing, the pair of scrubbers being positioned at the bottom end of the perimeter wall, the pair of scrubbers being spaced inwardly of the perimeter wall of the housing, the pair of scrubbers being oriented parallel to each other, each scrubber of the pair of scrubbers being oriented to extend between a front side and a rear side of said housing;
a pair of scrubber motors, each scrubber motor of the pair of scrubber motors being operatively coupled to an associated scrubber of the pair of scrubbers, the pair of scrubber motors being operatively coupled to the processor;
a reservoir being mounted in the housing, the reservoir being configured to contain a cleaning fluid;
a plurality of spray nozzles being mounted in the housing and being in fluid communication with the reservoir, each spray nozzle of the plurality of spray nozzles having an outlet facing downwardly with respect to the housing;
a cleaning pump being in fluid communication with the reservoir and the plurality of spray nozzles, the cleaning pump being operatively coupled to the processor, the cleaning pump being configured to selectively urge the cleaning fluid from the reservoir through the plurality of spray nozzles;
a pair of arms being mounted to the housing, each arm of the pair of arms being positioned on an associated one of a pair of lateral sides of the housing, each arm of the pair of arms being pivotable between a storage position and a use position, each arm of the pair of arms extending downwardly from a coupled end of the arm to a free end of the arm when in the storage position, each arm of the pair of arms extending laterally away from the housing from the coupled end to the free end when in the use position, each arm of the pair of arms being telescopically extendable to selectively adjust a length of the arm from the coupled end to the free end;
a pair of handles, each handle of the pair of handles being coupled to the free end of an associated arm of the pair of arms;
an input being operatively coupled to the processor, the input being embedded in one of the pair of handles, the input comprising a force sensor;
a pair of lifts mounted in the housing, the pair of lifts being coupled to the top wall and the perimeter wall, the pair of lifts being operable to move the top wall linearly between the raised position and the lowered position;
a pair of arm position sensors being mounted to the housing, each arm position sensor of the pair of arm position sensors being configured to detect when an associated arm of the pair of arms is positioned in the storage position, the processor being configured to cause the pair of lifts to move the top wall to the raised position when each arm of the pair of arms is moved away from the storage position, the processor being configured to cause the pair of lifts to move the top wall to the lowered position when each arm of the pair of arms is moved into the storage position;
a guide light source being coupled to a front side of the housing and being operatively coupled to the processor, the guide light source being configured to emit a light forwardly with respect to the housing;
a power supply being electrically coupled to the processor, the power supply comprising a battery;
a solar cell mounted to the exterior of the housing and being positioned on the top wall, the solar cell being electrically coupled to the battery;
a door being coupled to the front side of the housing, the door being positioned adjacent to the receptacle when the receptacle is coupled to the outlet end of the tube, the door being movable between an open position and a closed position, the receptacle being accessible through an aperture in the housing only when the door is in the open position;
a pair of lower eyelets being coupled to the housing, each lower eyelet of the pair of lower eyelets being positioned on an associated one of the pair of lateral sides of the housing; and
a pair of upper eyelets, each upper eyelet being coupled to an associated arm of the pair of arms;
wherein the pair of lower eyelets and the pair of upper eyelets are configured to attach to a plurality of straps to facilitate carrying the housing.
